(19) United States
(12) Patent Application Publication
(10) Pub. No.: US 2023/0084404 A1
(43) Pub. Date: Mar. 16, 2023

(54) EXPLICIT WAITING CONTROLS FOR A COMMUNICATION SYSTEM

(71) Applicant: Intercom, Inc., San Francisco, CA (US)

(72) Inventors: Eoin Nolan, Dublin (IE); Alex Potrivaev, Dublin (IE)

(21) Appl. No.: 17/669,640

(22) Filed: Feb. 11, 2022

Related U.S. Application Data
(60) Provisional application No. 63/243,003, filed on Sep. 10, 2021.

(51) Int. Cl. G06Q 30/00; H04L 67/60; H04L 67/51

(52) U.S. Cl. CPC G06Q 30/016; H04L 67/32; H04L 67/16

(57) ABSTRACT

Methods and systems for optimizing timing of sending communications to a user device are disclosed. The method includes performing a first check for a completion of a task. The method includes sending a completion message responsive to the first check being true and performing a send check after an elapse of a predetermined amount of time responsive to the first check being false. The method includes sending the completion message responsive to the second check being true and sending an enticement message responsive to the second check being false. The method includes performing a third check responsive to the sending the enticement message and sending the completion message responsive to the third check being true.

### CROSS-REFERENCE TO RELATED APPLICATION

This application claims priority to, and benefit of, U.S. Provisional Patent Application No. 63/243,003, filed Sep. 10, 2021, the entire contents of which are hereby incorporated by reference.

### TECHNICAL FIELD

The present disclosure relates to systems and methods for managing communications and, more specifically, systems and methods for managing communications with users and potential users of a system.

### BACKGROUND

Customer relationship management (CRM) software is software that automates and manages interactions with an organization. A conversational messaging system may allow an organization to define conversational experiences for commerce, marketing, and support using in-product channels (chatbots, live messaging, banners) and out-of-product channels (email and SMS messages). CRM software or conversational messaging systems may be used by an organization to maintain contact with customers and quickly respond to their needs. CRM software or conversational messaging systems may be used by an organization to increase engagement with the organization.

### SUMMARY

One aspect disclosed herein is directed to a method that includes performing a first check for a completion of a task. The method includes sending a completion message responsive to the first check being true and performing a send check after an elapse of a predetermined amount of time responsive to the first check being false. The method includes sending the completion message responsive to the second check being true and sending an enticement message responsive to the second check being false. The method includes performing a third check responsive to the sending the enticement message and sending the completion message responsive to the third check being true.

In another aspect, the present disclosure is directed to a system that includes a memory and a processing device that is operatively coupled to the memory. In some embodiments, the processing device performs a first check for a completion of a task. In some embodiments, when the first check is true, the processing device sends a completion message to a user device and when the first check is false the processing device performs a second check for the completion of the task after an elapse of a predetermined amount of time. In some embodiments, the processing device sends the completion message to the user device when the second check is true and sends an enticement message to the user device when the second check is false. In some embodiments, the processing device includes performing a third check in response to sending the enticement message. In some embodiments, the processing device sends the completion message to the user device when the third check is true.

In another aspect, the present disclosure is directed to a non-transitory computer-readable medium storing instructions that, when executed by a processing device, cause the processing device to perform a first check for a completion of a task. In some embodiments, the instructions may cause the processing device to send a completion message to a user device when the first check is true and perform a second check for the completion of the task after an elapse of a predetermined amount of time when the first check is false. In some embodiments, the instructions may cause the processing device to send the completion message to the user device when the second check is true and send an enticement message to the user device when the second check is false. In some embodiments, the instructions may cause the processing device to perform a third check for the completion of the second task in response to sending the enticement message. In some embodiments, the instructions may cause the processing device to send the completion message to the user device when the third check is true.

It will therefore be appreciated that this Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects, and advantages will become apparent from the following detailed description taken in conjunction with the accompanying figures which illustrate, by way of example, the principles of some described example implementations.

Further, to the extent consistent, any of the embodiments or aspects described herein may be used in conjunction with any or all of the other embodiments or aspects described herein.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram depicting an example environment for managing communications with users and potential users of a communication system, according to some embodiments;

FIG. 1B is a block diagram depicting an example of the communication system of FIG. 1A, according to some embodiments;

FIG. 1C is a block diagram depicting an example of the end user device of FIG. 1A, according to some embodiments;

FIG. 2 is a block diagram of an example control for providing a message to a user, according to some embodiments;

FIG. 3 is a block diagram of an example control that provides a solution for preventing a message from being sent before a user has an opportunity to complete a task, according to some embodiments;

FIG. 4 is a block diagram of an example explicit waiting control, according to some embodiments;

FIG. 5 is a flow chart of a method of executing the example explicit waiting control of FIG. 4, according to some embodiments; and

FIG. 6 is a block diagram of an example computing device 600 that may perform one or more of the operations described herein, according to some embodiments.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements.

As used herein, the term “communication system” may refer to the system and/or program that manages communications between individuals and companies. The term “customer” may refer to a company or organization utilizing the communication system to manage relationships with its end users or potential end users (leads). The term “user” may refer to an end user or lead that is interfacing with the customer through the communication system. The term “company” may refer to an organization or business that includes a group of users. The term “engineer” may refer to staff managing or programing the communication system. The term “product” may refer to a website, application, or program of the customer.

As described in the below passages, the communication system may place (e.g., assign, allocate) user objects associated with a user device of a user into user paths developed by a customer, monitor interaction of users with customer products, and communicate with the users via the user device based on interactions with the customer products to advance user objects through the user paths. The communication system may monitor and/or detect interactions of the user with the customer's product and advance the user objects along the user paths based on conditions set by the customer during development of the user paths. The interactions of the users may include, but not be limited to, accessing a product, moving through pages within the product, utilizing features of the product or making a purchase within the product. The communication system, the customer, and/or third party software may communicate with the users via the user devices as the user objects are advanced through the user paths. Communications with the users may include, but not be limited to, banners, pop-ups, chat windows, in product direct messaging, emails, push messages, instant messages, or short message service (SMS) messages. The communication system may include reporting functions that allow a customer to monitor the status of user objects along the developed user paths.

During use of a communication system, a customer may want to send a completion message to a user when a task is completed and send an encouraging or an enticement message to the user if the user does not complete the task within a predetermined amount of time. Existing communication systems may have the ability to send a completion message and an enticement message; however, existing communication systems do not deliver the completion message and the enticement message in a timely manner. As described in greater detail below, existing communication systems may deliver the enticement message before a user has had an opportunity to complete the task. Existing communication systems may delay the delivery of the completion message for an amount of time to allow the user to complete the task. Mistiming the delivery of the completion and enticement message may decrease a user's perception of the product or the customer. In some embodiments, mistiming the delivery of the completion message and/or the enticement message may increase a cost of a sale of a customer or conversion of a user for the customer and thus, reduce customer profits.

As described in greater detail below, a control for a communication system is disclosed that is capable of optimizing the timing of delivering messages such as a completion message and an enticement message. As described below, optimizing the timing of a completion message may be delivering the completion message as soon as or shortly after an associated task is completed and optimizing the timing of the enticement message may be allowing a user an opportunity to complete an associated task before sending the enticement message.

Optimizing the timing of a completion message and an enticement message may increase a user's perception of the product and/or the customer. Optimizing the timing of a completion message and an enticement message may decrease a cost of a sale for a customer compared to other communication systems and thus, may increase a customer's profit with respect to other communication systems. Increasing a user's perception of a product may increase the likelihood that the user will remain engaged with the product and/or the customer.

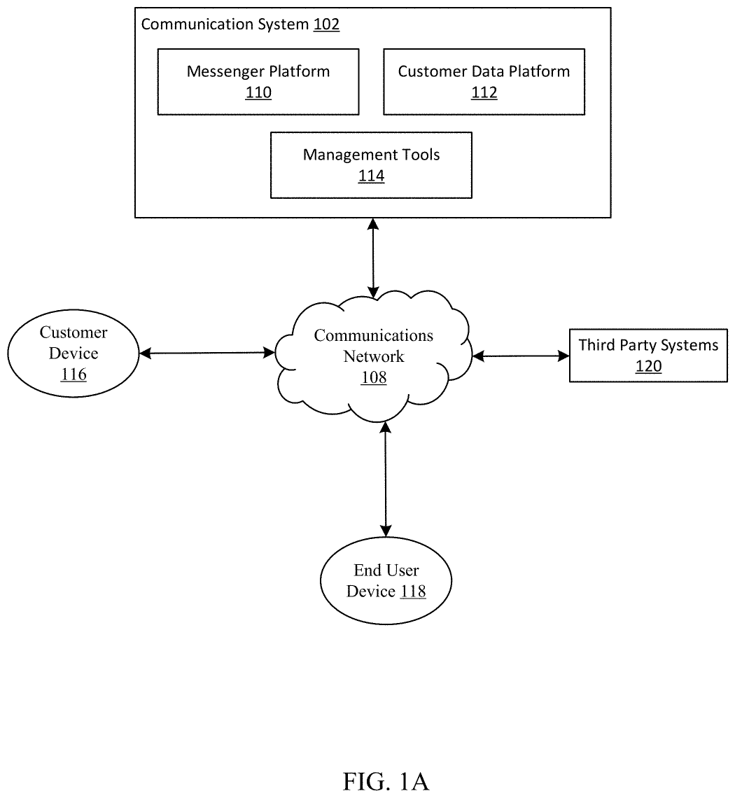

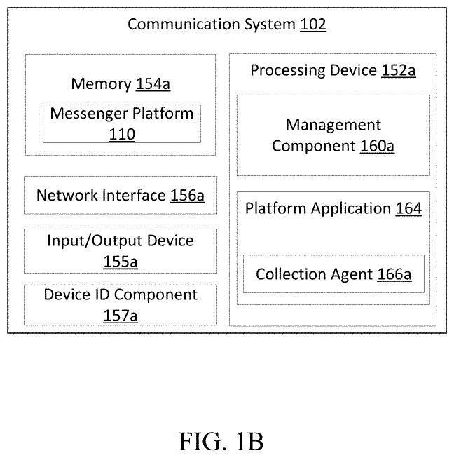

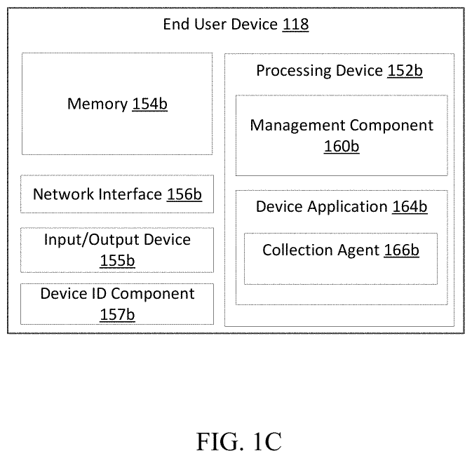

FIG. 1A is a block diagram depicting an example environment for managing communications with users and potential users of a communication system, according to some embodiments. As shown, the environment 100 includes a communication system 102 that is interconnected with a customer device 116, an end user device 118, and third party systems 120 via a communications network 108. The communications network 108 may be the internet, a wide area network (WAN), intranet, or other suitable network. The communication system 102 may be hosted on one or more local servers, may be a cloud based system, or may be a hybrid system with local servers and in the cloud. The communication system 102 is maintained by engineers which develop management tools 114 that include an interface or editor for clients of the communication system 102 to interface with the communication system 102.

The communication system 102 includes management tools 114 that are developed to allow customers to develop user series or user paths in the form of nodes and edges (e.g., connections) that are stored in a customer data platform 112 of the communication system 102. The communication system 102 includes a messenger platform 110 that interacts with end user devices 118 in accordance with the user paths stored in the customer data platform 112.

A customer interacts with the communication system 102 by accessing a customer device 116. The customer device 116 may be a general purpose computer or a mobile device. The customer device 116 allows a customer to access the management tools 114 to develop the user paths stored in the customer data platform 112. For example, the customer device 116 may execute an application using its hardware (e.g., a processor, a memory) to send a request to the communication system 102 for access to a graphical editor, which is an application programming interface (API) stored in the management tools 114. In response to receiving the request, the communication system 102 may send a software package (e.g., executable code, interpreted code, programming instructions, libraries, hooks, data, etc.) to the customer device 116 to cause the customer device 116 to execute the software package using its hardware (e.g., processor, memory). In some embodiments, the application may be a desktop or mobile application, or a web application (e.g., browser). The customer device 116 may utilize the graphical editor to build the user paths within the graphical editor. The graphical editor may periodically send copies (e.g., snapshots) of the user path as it is being built to the communication system 102, which in turn, may store the user paths to the customer data platform 112. The user paths manage communication of the customer with a user to advance a user object associated with the user through the user paths. The user paths may be developed to increase engagement of a user with the customer via the messenger platform 110.

The messenger platform 110 may interact with a user through an end user device 118 that accesses the communication network 108. The end user device 118 may be a general purpose computer or mobile device that accesses the communication network 108 via the internet or a mobile network. The user may interact with the customer via a website of the customer, a messaging service, or interactive chat. In some embodiments, the user paths may allow a customer to interface with users through mobile networks via messaging or direct phone calls. In some embodiments, a customer may develop a user path in which the communication system 102 interfaces with a user device via a non-conversational channel such as email.

The communication system 102 includes programs or workers that place user objects into the user paths developed by the customers stored in the customer data platform 112. The communication system 102 may monitor progress of the user objects through the user paths developed by the customer and interact with the customer based on the nodes and edges developed by the customer for each user path. In some embodiments, the communication system 102 may remove user objects from user paths based on conditions developed by the customer or by the communication system 102.

The communication system 102 and/or the customers may employ third party systems 120 to receive (e.g., retrieve, obtain, acquire), update, or manipulate (e.g., modify, adjust) the customer data platform 112 or user data which is stored in the customer data platform 112. For example, a customer may utilize a third party system 120 to have a client chat directly with a user via the end user device 118 or may utilize a bot (e.g., a software program that performs automated, repetitive, and/or pre-defined tasks) to interact with a user via the end user device 118 via chat or messaging.

Although FIG. 1A shows only a select number of computing devices and/or systems (e.g., communication system 102, customer device 116, third party systems 120, and end user device 118), the environment 100 may include any number of computing devices and/or systems that are interconnected in any arrangement to facilitate the exchange of data between the computing devices and/or systems.

FIG. 1B is a block diagram depicting an example of a communication system 102 of FIG. 1A, according to some embodiments. While various devices, interfaces, and logic with particular functionality are shown, it should be understood that the communication system 102 includes any number of devices and/or components, interfaces, and logic for facilitating the functions described herein. For example, the activities of multiple devices may be combined as a single device and implemented on a same processing device (e.g., processing device 152a), as additional devices and/or components with additional functionality are included.

The communication system 102 includes a processing device 152a, a memory 154a, an input/output device 155a, a network interface 156a, and a device ID component 157a. The memory 154a may include the messenger platform 110 stored therein. The processing device 152a may include a management component 160a or a platform application 164a. The platform application 164a may include a collection agent 166a.

The processing device 152a of the messenger platform 110 may perform checks for the completion of a task. The task may be completed by the platform application 156 or the end user device 118. The processing device 152a may send messages to the end user device 118 responsive to the checks, e.g., the checks being true or false. The messages sent by the processing device 152a may be sent via an in-product channel or an out-of-product channel. In certain embodiments, the messages may be sent as an email. The processing device 152a may advance a user object through a user path executed by the processing device 152a.

The processing device 152a includes (e.g., general purpose processor, a PLD, etc.), which may be composed of one or more processors, and a memory 154a (e.g., synchronous dynamic random access memory (DRAM), read-only memory (ROM)), which may communicate with each other via a bus (not shown).

The processing device 152a may be provided by one or more general-purpose processing devices such as a microprocessor, central processing unit, or the like. In some embodiments, processing device 152a may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 152a may comprise one or more special-purpose processing devices such as an application specific integrated circuit (ASIC), a field programmable gate array (FPGA), a digital signal processor (DSP), network processor, or the like. The processing device 152a may be configured to execute the operations described herein, in accordance with one or more aspects of the present disclosure, for performing the operations and steps discussed herein.

The processing device 152a may include and/or execute an application (shown in FIG. 1B as, “platform application 164a”) that is displayed on a computer screen of the communication system 102. In some embodiments, the platform application 164a may be an application that is or has undergone one or more stages of a software development process for the purpose of developing the application into a final product for private use, public use, and/or commercial use. In some embodiments, the platform application 164a may be configured to need one or more computing resources (e.g., networking resources, data storage resources, processing resources, one or more files) in order to completely execute (e.g., execute without error and/or interruption). In some embodiments, the platform application 164a may be configured to send a communication, via the communications network 108 (shown in FIG. 1A) to the customer device 116 or the end user device 118.

The platform application 164a may include a collection agent 166a. The collection agent 166a may include an application plug-in, application extension, subroutine, browser toolbar, daemon, or other executable logic for collecting data processed by the platform application 164a and/or monitoring interactions of the end user device 118. In other embodiments, the collection agent 166a may be a separate application, service, daemon, routine, or other executable logic separate from the platform application 164a but configured for intercepting and/or collecting data processed by platform application 164a, such as a screen scraper, packet interceptor, application programming interface (API) hooking process, or other such application. The collection agent 166a may capture interactions with a product, e.g., a website, an application, or a program, by the end user device 118. In some embodiments, the collection agent 166a generates collection data based on communications received from end user device 118 via the network interface 156a by way of the communications network 108.

The processing device 152a may execute a management component 160a. In some embodiments, the management component 160a may be configured to launch and/or execute a user path. In some embodiments, the management component 160a may be configured to launch (e.g., start, trigger, activate) the platform application 164a to cause platform application 164a to execute on the processing device 152a. The management component 160a may identify and move user objects representative of a user interfacing with the messenger platform 110 via an end user device 118 through the user paths. At times, the user paths and/or the user objects may store in the memory 154a.

The memory 154a (e.g., Random Access Memory (RAM), Read-Only Memory (ROM), Non-volatile RAM (NVRAM), Flash Memory, hard disk storage, optical media, etc.) stores data and/or computer instructions/code for facilitating at least some of the various processes described herein. The memory 154a includes tangible, non-transient volatile memory, or non-volatile memory. The memory 154a stores programming logic (e.g., instructions/code) that, when executed by the processing device 152a, controls the operations of the messenger platform 110. In some embodiments, the processing device 152a and the memory 154a form various processing devices and/or circuits described with respect to the messenger platform 110. The instructions include code from any suitable computer programming language such as, but not limited to, C, C++, C#, Java, JavaScript, VBScript, Perl, HTML, XML, Python, TCL, and Basic.

The communication system 102 includes a network interface 156a configured to establish a communication session with a computing device for sending and receiving data over the communication network 108 to the computing device. Accordingly, the network interface 156a includes a cellular transceiver (supporting cellular standards), a local wireless network transceiver (supporting 802.11X, ZigBee, Bluetooth, Wi-Fi, or the like), a wired network interface, a combination thereof (e.g., both a cellular transceiver and a Bluetooth transceiver), and/or the like. In some embodiments, the communication system 102 includes a plurality of network interfaces 156a of different types, allowing for connections to a variety of networks, such as local area networks (public or private) or wide area networks including the Internet, via different sub-networks.

The communication system 102 may include an input/output device 155a configured to receive input from and provide information to engineers. In this regard, the input/output device 155a is structured to exchange data, communications, instructions, etc. with an input/output component of the communication system 102. Accordingly, input/output device 155a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interfaces may be internal to the housing of the communication system 102, such as a built-in display, touch screen, microphone, etc., or external to the housing of the communication system 102, such as a monitor connected to the communication system 102, a speaker connected to the communication system 102, etc., according to various embodiments. In some embodiments, the communication system 102 includes communication circuitry for facilitating the exchange of data, values, messages, and the like between the input/output device 155a and the components of the communication system 102. In some embodiments, the input/output device 155a includes machine-readable media for facilitating the exchange of information between the input/output device 155a and the components of the communication system 102. In still another embodiment, the input/output device 155a includes any combination of hardware components (e.g., a touchscreen), communication circuitry, and machine-readable media.

The communication system 102 includes a device identification component 157a (shown in FIG. 1B as device ID component 157a) configured to generate and/or manage a device identifier associated with the communication system 102. The device identifier may include any type and form of identification used to distinguish the communication system 102 from other computing devices. In some embodiments, to preserve privacy, the device identifier may be cryptographically generated, encrypted, or otherwise obfuscated by any device and/or component of communication system 102. In some embodiments, the communication system 102 may include the device identifier in any communication (e.g., establish connection request, resource request) that the communication system 102 sends to a computing device.

The communication system 102 includes a bus (not shown), such as an address/data bus or other communication mechanism for communicating information, which interconnects the devices and/or components of communication system 102, such as processing device 152a, memory 154a, network interface 156a, input/output device 155a, device ID component 157a, and management component 160a.

In some embodiments, some or all of the devices and/or components of the messenger platform 110 may be implemented with the processing device 152a. For example, the messenger platform 110 may be implemented as a software application stored within the memory 154a and executed by the processing device 152a. Accordingly, such embodiments can be implemented with minimal or no additional hardware costs. In some embodiments, any of these above-recited devices and/or components rely on dedicated hardware specifically configured for performing operations of the devices and/or components.

FIG. 1C is a block diagram depicting an example of an end user device of FIG. 1A (e.g., end user device 118) of the environment in FIG. 1, according to some embodiments. While various devices, interfaces, and logic with particular functionality are shown, it should be understood that the end user device 118 includes any number of devices and/or components, interfaces, and logic for facilitating the functions described herein. For example, the activities of multiple devices may be combined as a single device and implemented on a same processing device (e.g., processing device 152b), as additional devices and/or components with additional functionality are included.

The end user device 118 includes a processing device 152b, a memory 154b, an input/output device 155b, a network interface 156b, and a device ID component 157b. The processing device 152b may include a management component 160b or a device application 164b. The device application 164b may include a collection agent 166b.

The end user device 118 includes the processing device 152b (e.g., general purpose processor, a PLD, etc.), which may be composed of one or more processors. The processing device 152b includes identical or nearly identical functionality as processing device 152a in FIG. 1B, but with respect to devices and/or components of the end user device 118 instead of devices and/or components of the communication system 102.

The processing device 152b may execute a device application 164b that is communicably coupled to the communication network 120 allowing the end user device 118 to send/receive data (e.g., requests, end user data, application data, user inputted data, etc.) to any other computing devices connected to the communication network 120. The device application 164b is configured to display information (e.g., application data) that the end user device 118 receives from any other computing device (e.g., communication system 102). The device application 164b may be an internet/web browser, a graphic user interface (GUI), an email reader/client, a file transfer protocol (FTP) client, a virtual machine application, or a software application that is spate from an internet/web browser. The device application 164 may be or interact with a product monitored by the collection agent 166a of the communication system 102.

The device application 164b includes a collection agent 166b. The collection agent 166b may include an application plug-in, application extension, subroutine, browser toolbar, daemon, or other executable logic for collecting data processed by the device application 164b and/or monitoring interactions of user with the input/output device 155b. In other embodiments, the collection agent 166b may be a separate application, service, daemon, routine, or other executable logic separate from the device application 164b but configured for intercepting and/or collecting data processed by device application 164b, such as a screen scraper, packet interceptor, application programming interface (API) hooking process, or other such application. The collection agent 166a is configured for intercepting or receiving data input via the input/output device 157b, including mouse clicks, scroll wheel movements, gestures such as swipes, pinches, or touches, or any other such interactions; as well as data received and processed by the device application 164b. The collection agent 166b is configured to pass any data that it intercepts, gathers, and/or receives data to the device application 164b to be presented in the device application 164b (e.g., on a display/monitor) and/or for the application to sends the data to the messenger platform 110. In some embodiments, the collection agent 116b may be embedded in code received by and executed by the device application 164b. When executed, the collection agent 116b may gather and generate engagement information or data from the end user device 118 representative of activity of a user with the end user device 118 and/or engagement of the user with a product. The collection agent 116b may transmit the engagement data with the collection agent 166a of the communication system 102 via the network interface 156a by way of the communication network 108. The collection agent 116b, may begin intercepting, gathering, and/or receiving data input via its respective input/output circuit in view of any triggering event, including, e.g., a power-up of the end user device 118 or a launch of any software application executing on a processing device of end user device 118. In some embodiments, the collection agent 166b may begin intercepting, gathering, and/or receiving data responsive to a user scanning a quick response (QR) code associated with a product identifier or a barcode associated with a product identifier.

The memory 154b stores data and/or computer instructions/code for facilitating at least some of the various processes described herein. The memory 154b includes identical or nearly identical functionality as the memory 154a in FIG. 1B, but with respect to devices and/or components of the end user device 118 instead of devices and/or components of the communication system 102.

The end user device 118 includes a network interface 156b configured to establish a communication session with a computing device for sending and receiving data over a network to the computing device. Accordingly, the network interface 156a includes identical or nearly identical functionality as the network interface 156a in FIG. 1B, but with respect to devices and/or components of the end user device 118 instead of devices and/or components of the communication system 102.

The input/output device 155b may be similar to the input/output device 155a in FIG. 1B, but with respect to devices and/or components of the end user device 118 instead of devices and/or components of the communication system 102.

The device identification component 157b may be similar to the device identification component 157a in FIG. 1B, but with respect to devices and/or components of the end user device 118 instead of devices and/or components of the communication system 102.

As noted above, it may be advantageous for a communication system to send a message to a user immediately upon completing a task or send a message to the user if the task has not been completed within a predetermined amount of time. Sending the message immediately may increase a user's perception of the product and/or the customer. In contrast, delaying the message until an arbitrary amount of time has passed by decrease user engagement with a product. In some embodiments, where a second message is sent when the task is not completed, may result in an unnecessary communication being sent to the user to encourage the user to complete the task. The unnecessary communication may cause a user to disengage with the product, cause the user to not complete the task, or unnecessarily reduce profit for the customer when the task is completed.

FIG. 2 is a block diagram of an example control 200 for providing a message to a user, according to some embodiments. When a user object is in a user path, the user path may have a message to send to the end user device 118 in response to an action being taken by the user device. At a first node 210, the communication system 102 may send a first message to the end user device 118 via an in-product channel or an out-of-product channel. After the first message is sent, a processing device 152a of the communication system 102 may advance the user object to the second node 220. In response to the end user device 118 completing a task associated with the second node 220, the processing device 152a of the communication system 102 may advance the user object to a fourth node 240 at which a third message is sent to the end user device 118. If the end user object does not complete the task 220, the user object is advanced to a third node 230 at which a second message 230 is sent to the end user device 118 and the user object is returned to the second node 220. When the end user device 118 completes the task associated with the second node 220, before or after the second message associated with the third node 230 is sent, the user object is advanced to the fourth node 240 and the third message associated with the fourth node 240 is sent to the end user device 118.

In some embodiments, the second message associated with the third node 230 will be sent if the end user device 118 does not complete the task associated with the second node 220 before the processing device 152a of the communication system 102 checks to determine if the task associated with the second node 220 is completed. In certain embodiments, the processing device 152a of the communication system 102 may check if the task associated with the second node 220 is completed almost immediately or shortly after the first message was sent when the user reached the first node 210. As such, the second message associated with the third node 230 will only be avoided if the end user device 118 completed the task associated with the second node 220 before the user object reached the first node 210.

In the example shown in FIG. 2, the result would be a user finding out about a sale and receiving an additional discount before having the opportunity to shop the sale or make a purchase. As such, profits of the customer may be reduced from providing discounts to users who would have made the purchase regardless of whether the additional discount was offered. The decrease in profits may affect a customer's perception of the communication system.

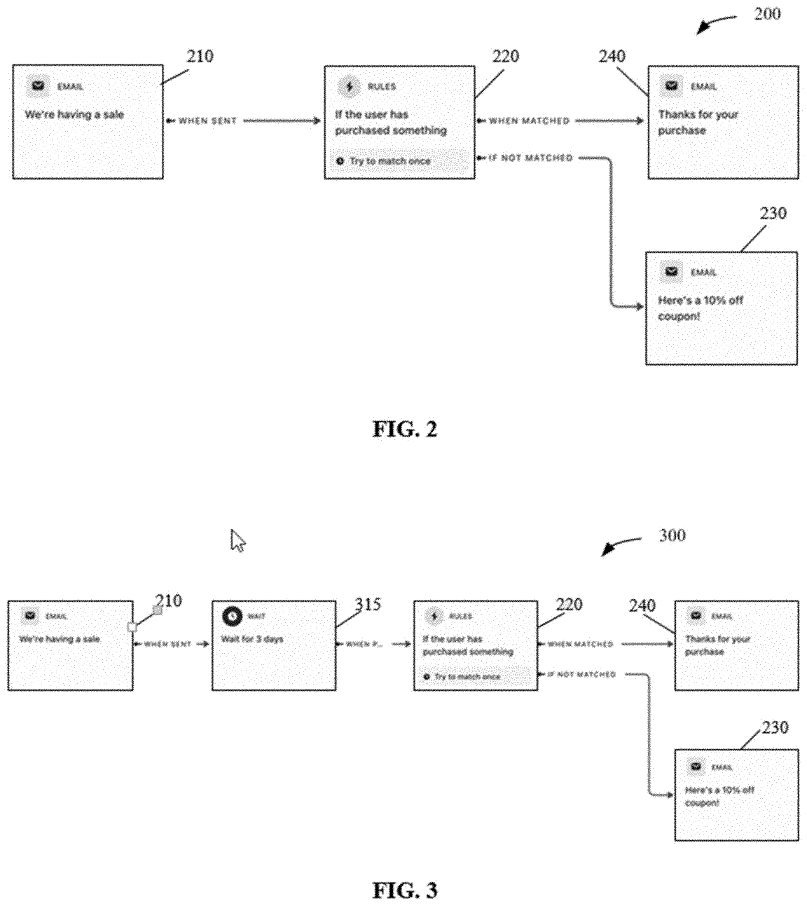

FIG. 3 is a block diagram of an example control 300 that provides a solution for preventing a message (e.g., the second message associated with the third node 230) from being sent before the user has an opportunity to complete a task with the end user device 118 (e.g., the task associated with the second node 220), according to some embodiments. Control 300 includes a waiting period or delay 315 between the first node 210 and the second node 220. This delay 315 gives the user an opportunity to complete the task associated with the second node 220 before receiving the second message associated with the third node 230. While this solves the problem of the user receiving the second message before having the opportunity to complete the task associated with the second node 220, the delay 315 may delay the third message associated with the fourth node 240 from being sent once the task associated with the second node 220 is completed by the user. As such, while the delay 315 prevents the second message from being prematurely sent, the delay 315 may prevent the third message from being timely sent.

In the example shown in FIG. 3, once a user is notified of a sale by the first message being sent when the user reached the first node 210, the user would not receive any subsequent communications from the customer until the waiting period or delay 315 has elapsed. In this example, if the user made a purchase immediately after receiving the message informing the user of the sale, the user would not be thanked for the purchase for three days. As a result of the delay 315, a user's perception of the customer or product may be damaged.

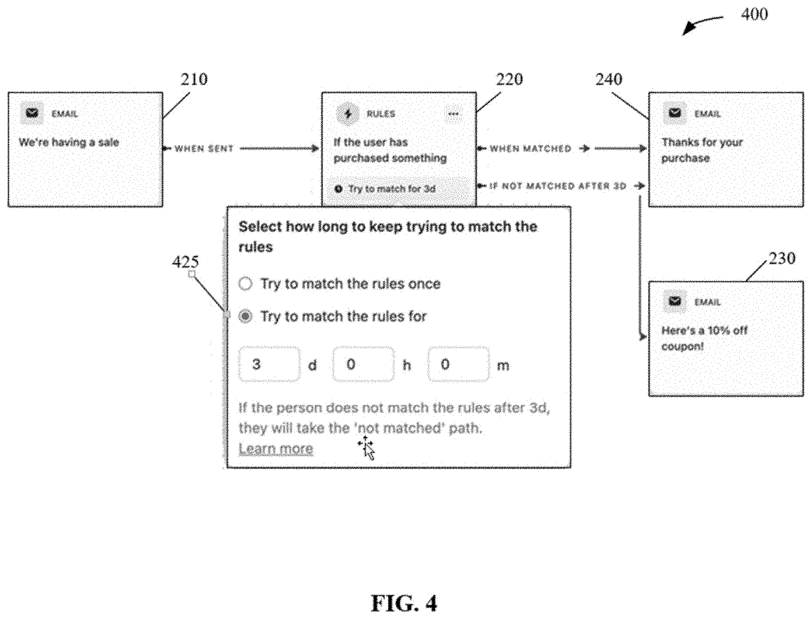

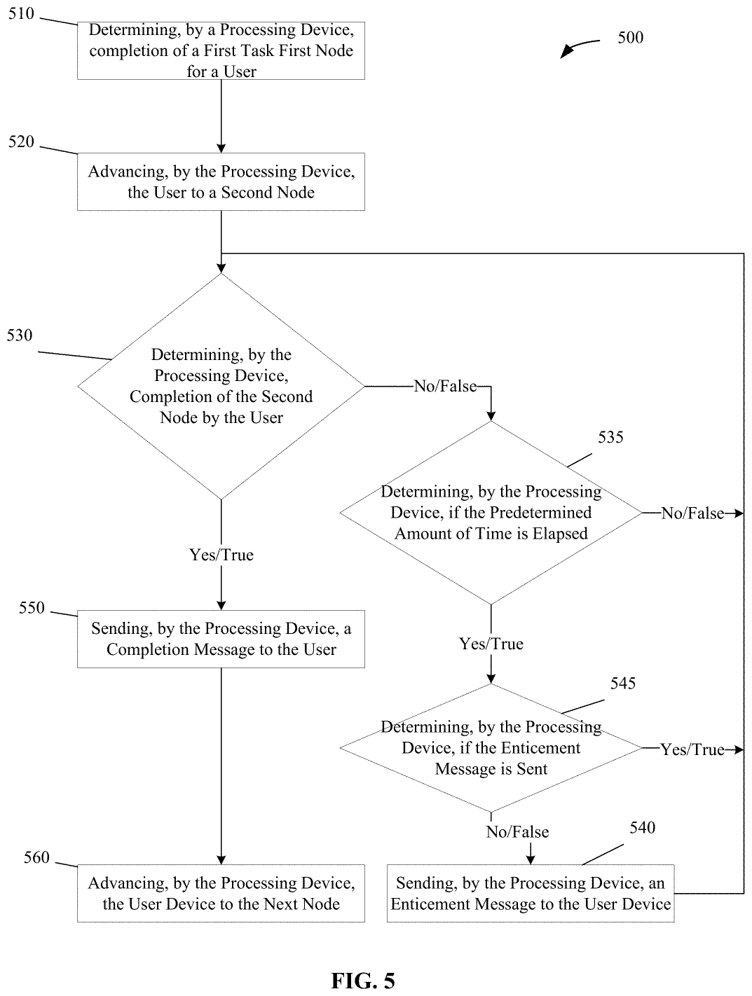

Referring now to FIGS. 4 and 5, an explicit waiting control and a method of executing the explicit waiting control is provided in accordance with an embodiment of the present disclosure which are referred to as control 400 and method 500, respectively. The control 400 allows for the second message associated with the third node 230 to be sent if the task associated with the second node 220 is not completed in a predetermined amount of time or waiting period 325 and the third message associated with the fourth node 240 to be sent when the task associated with the second node 220 is completed without requiring the waiting period 325 to be exhausted.

The method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, one or more of the operations of method 500 may be performed by the communication system 102, the customer device 116, the end user device 118, and/or the third party system 120 of FIG. 1A. In some embodiments, the method 500 may be executed on the processing device 152a of the communication system 102 of FIG. 1A.

The explicit waiting control 400 may be initiated when a task associated with the first node 210 is completed (Operation 510). As shown, the first node 210 is completed when the processing device 152a of the communication system 102 sends the first message to the end user device 118. In some embodiments, the first node 210 may be completed when a task is completed by a user interfacing with the end user device 118. The processing device 152a of the communication system 102 may determine when the user completes a task associated with the first node 210. Upon completion of the task associated with the first node 210, the processing device 152a of the communication system 102 advances a user object representative of the user to the second node 220 (Operation 520). The user object remains at the second task until the task associated with the second node 220 is completed or the waiting period 425 elapses. When the user object reaches the second node 220, the processing device 152a of the communication system 102 checks for completion of the second task associated with the second node 220 (Operation 530). This checking may include the processing device 152a of the communication system 102 matching an element of data with the user object. In the example shown in FIG. 4, the processing device 152a of the communication system 102 may match a completed purchase with the user object to complete the task associated with the second node 220.

When the processing device 152a of the communication system 102 determines the completion of task associated with the second node 220, the processing device 152a of the communication system 102 immediately sends the third or completion message associated with the fourth node 240 to the end user device 118 (Operation 550). When the processing device 152a of the communication system 102 does not confirm the task associated with the second node 220 is completed, the processing device 152a of the communication system 102 periodically checks to determine if the task associated with the second node 220 is completed (Operation 530). The periodic checks may occur at preset intervals, e.g., 1 minute, 5 minutes, 10 minutes. These periodic checks continue for a predetermined amount of time or waiting period 425. The preset intervals may be set by the communication system 102. In some embodiments, the preset intervals may be varied to enhance performance of the communication system 102.

If the end user device 118 has not completed the task associated with the second node 220 within the predetermined amount of time, the processing device 152a of the communication system 102 may advance the user object to the third node 230 such that the second or enticement message is sent to the end user device 118 (Operation 540). As shown, the communication system 102 checks the amount of time since the user object is advanced to the second node 220 or since the completion of the task associated with the first node 210 against the predetermined amount of time between periodic checks to determine if the second task associated with the second node 220 has been completed (Operation 535). The predetermined amount of time may be set by the customer when the customer develops or builds the user path. The predetermined amount of time may be in a range of 1 minute to 365 days based on the task to be completed by the user. The customer may use the customer device 116 to provide the predetermined amount of time to the communication system 102.

After the second message associated with the third node 230 is sent, the user object is returned to the second node 220 until the end user device 118 completes the task associated with the second node 220. Once the user object is returned to the task 220, the processing device 152a of the communication system 102 may continue the periodic checks to determine if the end user device 118 completes the task associated with the second node 220 (Operation 530). In some embodiments, the processing device 152a of the communication system 102 may check to see if the second message associated with the third node 230 was sent before sending the second message associated with the third node 230 to prevent a duplicate second message from being sent (Operation 545). If the second message has been sent, the processing device 152a of the communication system 102 returns the user object to the second node 220 without sending the second message for a second time.

In embodiments, the checks for completion of the second task associated with the second node 220 may include a first check. When the first check is true (e.g., when the second task associated with the second node 220 is completed), the processing device 152a sends the completion message associated with the fourth node 240. When the first check is false (e.g., when the second task associated with the second node 220 is not completed), a second check for completion of the second task is performed after the elapse of the predetermined amount of time or waiting period 425. When the second check is true (e.g., when the second task associated with the second node 220 is completed), the processing device 152a sends the completion message associated with the fourth node 240. When the second check is false (e.g., when the second task associated with the second node 220 is not completed), a third check for completion of the second task is performed. When the third check is true (e.g., when the second task associated with the second node 220 is completed), the processing device 152a sends the completion message associated with the fourth node 240. When the third check is false (e.g., when the second task associated with the second node 220 is not completed), the third check is repeated until the third check is true. The processing device 152a advances the user object from the fourth node 240 to a subsequent node in response to sending the completion message associated with the fourth node 240.

In the example shown in FIG. 4, the explicit waiting control 400 allows a customer to encourage a user to make a purchase by sending a discount or coupon, e.g., enticement message associated with the third node 230, if the user does not make a purchase, e.g., the task associated with the second node 220, within a predetermined amount of time after being informed of a sale and to send a thank you message, e.g., the completion message associated with the fourth node 240, as soon as a purchase is made, e.g., completion of the task associated with the second node 220. Providing time for a user to complete a task before sending a subsequent message to the user to encourage or entice the task to be completed may provide a customer with additional options or increased flexibility over previous communication systems. The reduction in encouragement or enticement messages may increase a customer's profit. The increased flexibility may increase a customer's perception of the communication system 102. The immediate delivery of the subsequent message, e.g., the completion message, may increase a user's perception of the product or the customer.

As detailed above, the explicit waiting control 400 allows for a message to be sent when a task is completed but allows for a second message to be sent if the task is not completed within a predetermined amount of time. The predetermined amount of time may be set by a customer when building or developing a user path. The control 400 may enhance engagement of the user with a client by timely delivering a completion task message, e.g., third message associated with the fourth node 240, without delay and providing a client an option to send an intermediate message, e.g., second message associated with the third node 230, to encourage or entice the user to complete the task if not completed within the predetermined amount of time.

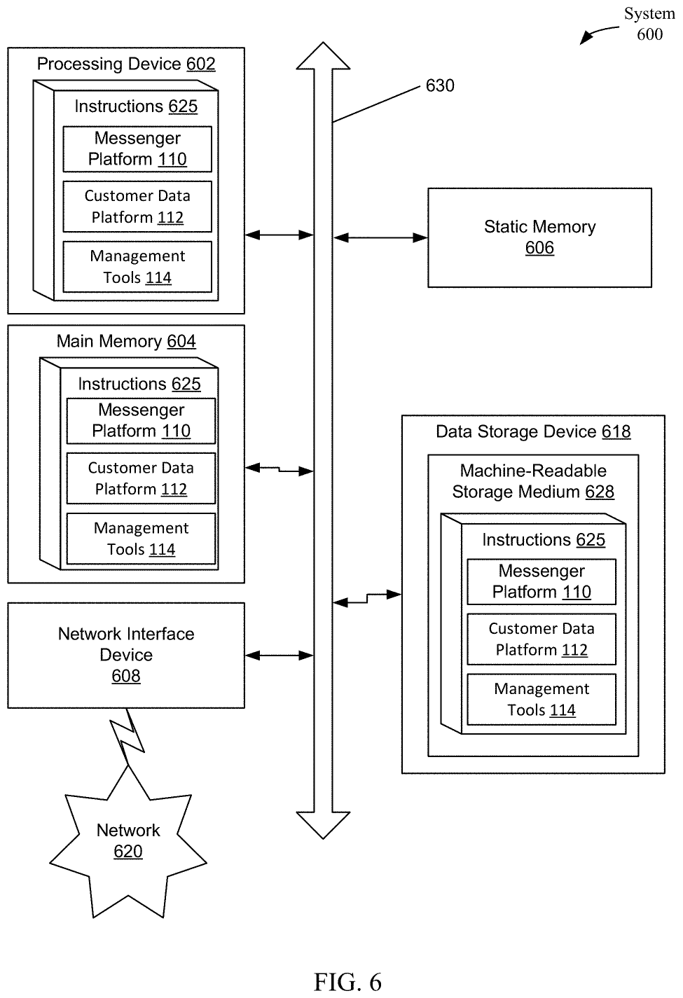

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in a client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. In some embodiments, while only a single computing device is illustrated, the term “computing device” may be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may include a network interface device 608 which may communicate with a communication network 620. The computing device 600 may include a video display unit 110 (e.g., a liquid crystal display (LCD) or a cathode ray tube (CRT)), an alphanumeric input device 112 (e.g., a keyboard), a cursor control device 114 (e.g., a mouse) and an acoustic signal generation device 616 (e.g., a speaker). In one embodiment, video display unit 110, alphanumeric input device 112, and cursor control device 114 may be combined into a single component or device (e.g., an LCD touch screen).

Data storage device 618 may include a computer-readable storage medium 628 on which may be stored one or more sets of instructions 625 that may include instructions for one or more components (e.g., messenger platform 110, the customer data platform 112, and the management tools 114) for carrying out the operations described herein, in accordance with one or more aspects of the present disclosure. Instructions 625 may reside, completely or at least partially, within main memory 604 and/or within processing device 602 during execution thereof by computing device 600, main memory 604 and processing device 602 constituting computer-readable media. The instructions 625 may be transmitted or received over a communication network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” may be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Examples described herein may relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. The terms “comprises”, “comprising”, “includes”, and/or “including”, when used herein, may specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

In some embodiments, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware, for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in a manner that is capable of performing the task(s) at issue. “Configured to” may include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present embodiments to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present embodiments are not to be limited to the details given herein, but may be modified within the scope and equivalents of the appended claims.

1. A method comprising:
performing, by a processing device, a first check for a completion of a task;
sending, by the processing device, a completion message to a user device responsive to the first check being true;
performing, by the processing device, a second check for completion of the task after an elapse of a predetermined amount of time responsive to the first check being false;
sending, by the processing device, the completion message to the user device responsive to the second check being true;
verifying, by the processing device, an enticement message has not been sent to the user device responsive to the second check being false;
generating and sending, by the processing device, the enticement message to the user device responsive to the verification being true;
performing, by the processing device, a third check for the completion of the task responsive to sending the enticement message or the verification being false; and
sending, by the processing device, the completion message to the user device responsive to the third check being true.

2. The method of claim 1, further comprising repeating the third check responsive to the third check being false at an interval of time, the processing device determining the interval of time to enhance performance of the processing device.

3. The method of claim 1, further comprising determining, by the processing device, a completion of an initial task prior to performing the first check.

4. The method of claim 3, further comprising sending, by the processing device, an initial message to the user device responsive to the completion of the initial task.

5. The method of claim 4, wherein sending the initial message comprises sending an email to the user device.

6. The method of claim 3, further comprising advancing, by the processing device, a user object associated with the user device to the first check responsive to the completion of the initial task.

7. The method of claim 1, further comprising advancing, by the processing device, a user object associated with the user device to a subsequent task responsive to the completion message being sent.

8. The method of claim 1, wherein determining completion of the task comprises a purchase being made via the user device.

9. The method of claim 1, further comprising receiving, by the processing device, the predetermined amount of time from a customer device.

10. The method of claim 1, further comprising repeating, by the processing device, the first check before the predetermined amount of time elapses responsive to the first check being false.

11. A system comprising:
a memory; and
a processing device, operatively coupled to the memory, to:
perform a first check for a completion of a task;
send a completion message to a user device responsive to the first check being true;
perform a second check for completion of the task after an elapse of a predetermined amount of time responsive to the first check being false;
send the completion message to the user device responsive to the second check being true;
verify an enticement message has not been sent to the user device responsive to the second check being false;
generate and send an enticement message to the user device responsive to the verification being true;
perform a third check for completion of the task responsive to sending the enticement message or the verification being false; and
send the completion message to the user device responsive to the third check being true.

12. The system of claim 11, wherein the processing device is further to repeat the third check responsive to the third check being false.

13. The system of claim 11, wherein the processing device is further to determine a completion of an initial task prior to performing the first check;

14. The system of claim 13, wherein the processing device is further to send an initial message to the user device responsive to completion of the initial task.

15. The system of claim 13, wherein the processing device is further to advance a user object associated with the user device to the first check responsive to the completion of the initial task.

16. The system of claim 11, wherein the processing device is further to advance a user object associated with the user device to a subsequent task responsive to the completion message being sent.

17. The system of claim 11, wherein determining completion of the task comprises a purchase being made via the user device.

18. The system of claim 11, wherein the processing device is further to receive the predetermined amount of time from a customer device.

19. The system of claim 11, wherein the processing device is further to repeated the first check before the predetermined amount of time elapses responsive to the first check being false.

20. A non-transitory computer-readable medium storing instructions that, when executed by a processing device, cause the processing device to:
perform a first check for a completion of a task;
send a completion message to a user device responsive to the first check being true;
perform a second check for the completion of the task after an elapse of a predetermined amount of time responsive to the first check being false;
send the completion message to the user device responsive to the second check being true;
verify an enticement message has not been sent to the user device responsive to the second check being false;
generate and send an enticement message to the user device responsive to the verification being true;
perform a third check for the completion of the task responsive to sending the enticement message or the verification being false; and
send the completion message to the user device responsive to the third check being true.
